(19) United States
(12) Patent Application Publication
(10) Pub. No.: US 2025/0063530 A1
(43) Pub. Date: Feb. 20, 2025

(54) ACCESS POINT, STATION, AND WIRELESS COMMUNICATION METHOD

(71) Applicant: GUANGDONG OPPO MOBILE TELECOMMUNICATIONS CORP., LTD., Dongguan (CN)

(72) Inventor: Lei HUANG, Singapore (SG)

(21) Appl. No.: 18/939,811

(22) Filed: Nov. 7, 2024

Related U.S. Application Data
(63) Continuation of application No. PCT/CN2022/092041, filed on May 10, 2022.

(51) Int. Cl. H04W 60/04; H04W 8/22; H04W 76/12

(52) U.S. Cl. CPC H04W 60/04; H04W 8/22; H04W 76/12

(57) ABSTRACT

A wireless communication method includes receiving, by a first STA, a beacon frame or a probe response frame, from a first AP. The first STA may be a type 1 STA affiliated with a non-AP multi-link device (MLD). The first AP may be a type 1 AP affiliated with an AP MLD that has zero or at least one affiliated type 2 AP. The beacon frame or the probe response frame may include a target beacon transmission time (TBTT) information field, a multi-link control field, and/or a common information field.

### CROSS-REFERENCE TO RELATED APPLICATION

This application is a Continuation Application of International Application No. PCT/CN2022/092041 filed May 10, 2022, which is incorporated herein by reference in its entirety.

### BACKGROUND OF DISCLOSURE

### 1. Field of the Disclosure

The present disclosure relates to the field of communication systems, and more particularly, to an access point (AP), a station (STA), and a wireless communication method, which can provide a good communication performance and/or provide high reliability.

### 2. Description of the Related Art

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineer (IEEE) 802.11) network may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

IEEE 802.11 TGbe is developing a new IEEE 802.11 amendment which defines extremely high throughput (EHT) physical layer (PHY) and medium access control (MAC) layers capable of supporting a maximum throughput of at least 30 Gbps. Further, it has been proposed to introduce multi-link operation (MLO) in sub-7 GHz band (including 2.4 GHz band, 5 GHz band, and 6 GHz band). IEEE 802.11 working group is also exploring a new amendment beyond IEEE 802.11be, which may target at a maximum throughput of at least 100 Gbps. To this end, it may be necessary to enable MLO in both sub-7 GHz band and mmW (>45 GHz) band. However, it is an open issue to enable MLO in both sub-7 GHz band and mmW band in an efficient manner in order to maximize system throughput.

Therefore, there is a need for an access point (AP), a station (STA), and a wireless communication method, which can solve issues in the prior art, improve system throughput, improve beam forming training, improve beam tracking, improve frequency diversity gain, reduce power consumption, achieve ultra high throughput, provide good communication performance, and/or provide high reliability.

### SUMMARY

In a first aspect of the present disclosure, a wireless communication method by a first STA comprises receiving, by the first STA, a beacon frame or a probe response frame, from a first access point (AP), wherein the first STA is a type 1 STA affiliated with a non-AP multi-link device (MLD).

In a second aspect of the present disclosure, a wireless communication method by a first AP comprises transmitting, by the first AP, a beacon frame or a probe response frame, to a first station (STA), wherein the first STA is a type 1 STA affiliated with a non-AP multi-link device (MLD).

In a third aspect of the present disclosure, a first STA comprises a receiver configured to receive a beacon frame or a probe response frame from a first access point (AP), wherein the first STA is a type 1 STA affiliated with a non-AP multi-link device (MLD).

In a fourth aspect of the present disclosure, a first AP comprises a transmitter configured to transmit, to a first station (STA), a beacon frame or a probe response frame, wherein the first STA is a type 1 STA affiliated with a non-AP multi-link device (MLD).

In a fifth aspect of the present disclosure, a first STA comprises a memory, a transceiver, and a processor coupled to the memory and the transceiver. The first STA is configured to perform the above method.

In a sixth aspect of the present disclosure, a first AP comprises a memory, a transceiver, and a processor coupled to the memory and the transceiver. The first AP is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a NG AP MLD with a Type 1 link (link 1) and a Type 2 link (link 2) according to an embodiment of the present disclosure.

FIG. 2A is a schematic diagram illustrating a procedure for discovery of a NG AP MLD by a NG non-AP MLD via a Type 1 link according to an embodiment of the present disclosure.

FIG. 2B is a schematic diagram illustrating a procedure for multi-link (re) setup between a NG AP MLD and a NG non-AP MLD via a Type 1 link according to an embodiment of the present disclosure.

FIG. 3A is a schematic diagram illustrating an RNR element according to an embodiment of the present disclosure.

FIG. 3B is a schematic diagram illustrating a Neighbor AP Information field according to an embodiment of the present disclosure.

FIG. 3C is a schematic diagram illustrating a format of TBTT Information Header subfield of a Neighbor AP Information field according to an embodiment of the present disclosure.

FIG. 3D is a schematic diagram illustrating a TBTT Information field according to an embodiment of the present disclosure.

FIG. 3E is a schematic diagram illustrating a format of a BSS Parameters subfield according to an embodiment of the present disclosure.

FIG. 3F is a schematic diagram illustrating a format of an MLD Parameters subfield according to an embodiment of the present disclosure.

FIG. 4A is a schematic diagram illustrating a format of a Multi-Link element according to an embodiment of the present disclosure.

FIG. 4B is a schematic diagram illustrating a format of a Multi-Link Control field of a Multi-Link element according to an embodiment of the present disclosure.

FIG. 5A is a schematic diagram illustrating a format of a Presence Bitmap subfield of a Basic Multi-Link element according to an embodiment of the present disclosure.

FIG. 5B is a schematic diagram illustrating a format of a Common Info field of a Basic Multi-Link element according to an embodiment of the present disclosure.

FIG. 5C is a schematic diagram illustrating a format of an MLD Capabilities and Operations field according to an embodiment of the present disclosure.

FIG. 5D is a schematic diagram illustrating a format of an Extended MLD Capabilities and Operations field according to an embodiment of the present disclosure.

FIG. 6A is a schematic diagram illustrating a format of a Per-STA Profile sub-element according to an embodiment of the present disclosure.

FIG. 6B is a schematic diagram illustrating a format of a STA Control field according to an embodiment of the present disclosure.

FIG. 6C is a schematic diagram illustrating a format of a STA Info field according to an embodiment of the present disclosure.

FIG. 7 is a schematic diagram illustrating an example of a wireless communications system according to an embodiment of the present disclosure.

FIG. 8 is a schematic diagram illustrating an example of a wireless communications system according to another embodiment of the present disclosure.

FIG. 9 is a block diagram of one or more stations (STAs) and access points (APs) of communication in a wireless communications system according to an embodiment of the present disclosure.

FIG. 10 is a flowchart illustrating a wireless communication method performed by a first AP according to an embodiment of the present disclosure.

FIG. 11 is a flowchart illustrating a wireless communication method performed by a first STA according to another embodiment of the present disclosure.

FIG. 12 is a block diagram of a first AP according to an embodiment of the present disclosure.

FIG. 13 is a block diagram of a first STA according to an embodiment of the present disclosure.

FIG. 14 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

TABLE 1

| Abbreviation | Full name |
|---|---|
| IEEE | Institute of electrical and electronics |
| | engineers |
| WLAN | Wireless local area network |
| BSS | Basic service set |
| BSSID | Basic service set identifier |
| AP | Access point |
| STA | Station |
| PHY | Physical layer |
| MAC | Medium access control |
| LLC | Logical link control |
| SAP | Service access point |
| SSID | Service set identifier |
| EHT | Extremely high throughput |
| UHT | Ultra high throughput |
| TXOP | Transmission opportunity |
| MLD | Multi-link device |
| MLO | Multi-link operation |
| NG | Next generation |
| DMG | Directional multi-gigabit |
| EDMG | Enhanced directional multi-gigabit |
| PSD | Power spectral density |
| RNR | Reduced neighbor report |
| TBTT | Target beacon transmission time |
| NSTR | Non-simultaneous transmit and receive |
| STR | Simultaneous transmit and receive |
| OCT | On-channel tunneling |
| ESS | Extended service set |
| EDCA | enhanced distributed channel access |

An MLD is a logical entity that is capable of supporting more than one STA but can also operate using one or more affiliated STAs and has one MAC data service and a single MAC SAP to the LLC sublayer. For example, the MLD may be a 11be MLD or a NG MLD. In some examples, the 11be MLD is a logical entity that is capable of supporting more than one affiliated Type 1 STA but can also operate using one or more affiliated STAs and has one MAC data service and a single MAC SAP to the LLC sublayer. A Type 1 STA is an STA that operates in 2.4 GHZ band, 5 GHz band or 6 GHz band. A 11be AP MLD is a 11be MLD where each STA affiliated with the 11be MLD is an AP. A 11be non-AP MLD is a 11be MLD where each STA affiliated with the 11be MLD is a non-AP STA. The MLO between two 11be MLDs (e.g., discovery of a 11be AP MLD by a 11be non-AP MLD) is defined in IEEE P802.11be/D1.5 or a later release.

In some examples, the NG MLD is a logical entity that is capable of supporting more than one affiliated STA but can also operate using one or more affiliated STAs and has one MAC data service and a single MAC SAP to the LLC sublayer. Each affiliated STA is a Type 1 STA or a Type 2 STA and at least one affiliated STA is a Type 1 STA. When a NG MLD operates using one or more affiliated STAs, the one or more affiliated STAs includes at least one affiliated Type 1 STA. A Type 2 STA is an STA that operates in mmW band. A NG AP MLD is a NG MLD where each STA affiliated with the NG MLD is an AP. A NG non-AP MLD is a NG MLD where each STA affiliated with the NG MLD is a non-AP STA. The MLO between two NG MLDs (e.g., discovery of a NG AP MLD by a NG non-AP MLD) needs to be defined. In some examples, the above-mentioned 11be MLD and NG MLD can be used as examples. It does not mean that MLD is only limited to device support in the 802.11be protocol and may also be used in other technical fields. Further, NG is also not limited to the next generation of the 802.11be protocol and may also be used in other technical fields.

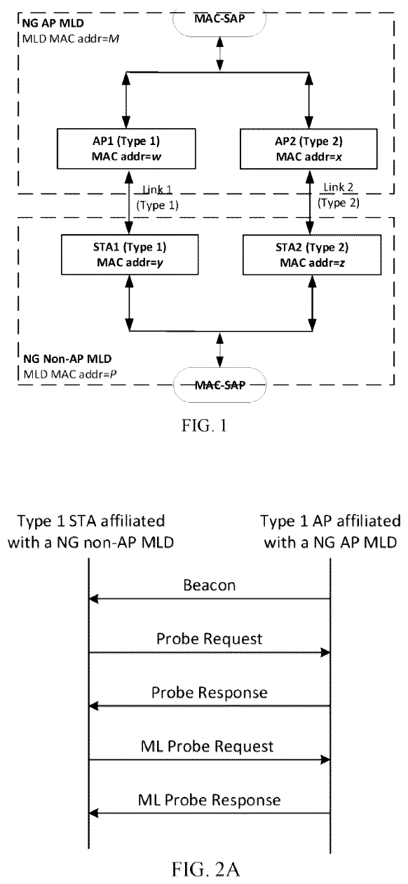

An example of a NG AP MLD with a Type 1 link (link 1) and a Type 2 link (link 2) is shown in FIG. 1. The NG AP MLD has MLD MAC address M, an affiliated Type 1 AP (AP1 with MAC address w) and an affiliated Type 2 AP (AP2 with MAC address x); and is associated by a NG non-AP MLD which has MLD MAC address P, an affiliated Type 1 STA (STA1 with MAC address y) and an affiliated Type 2 STA (STA2 with MAC address z). Link 1 is established between AP1 and STA1 and link 2 is established between AP2 and STA2. AP1 can be an example of Type 1 AP. A first AP can be a Type 1 AP in some examples of the present disclosure. A second AP can be another Type 1 AP in some examples of the present disclosure. AP2 can be an example of Type 2 AP. AP3 can be an example of another Type 1 AP. AP3 may be different from AP1. The other AP is an AP associated with the MLD other than the first and second APs. A third AP is the first AP or a type 1 AP affiliated with another AP MLD and operating at the same link as the first STA. STA1 can be an example of Type 1 STA. A first STA can be a Type 1 STA in some examples of the present disclosure. A second STA can be another Type 1 STA in some examples of the present disclosure. STA2 can be an example of Type 2 STA. The other STA is a STA associated with the MLD other than the first and second STAs.

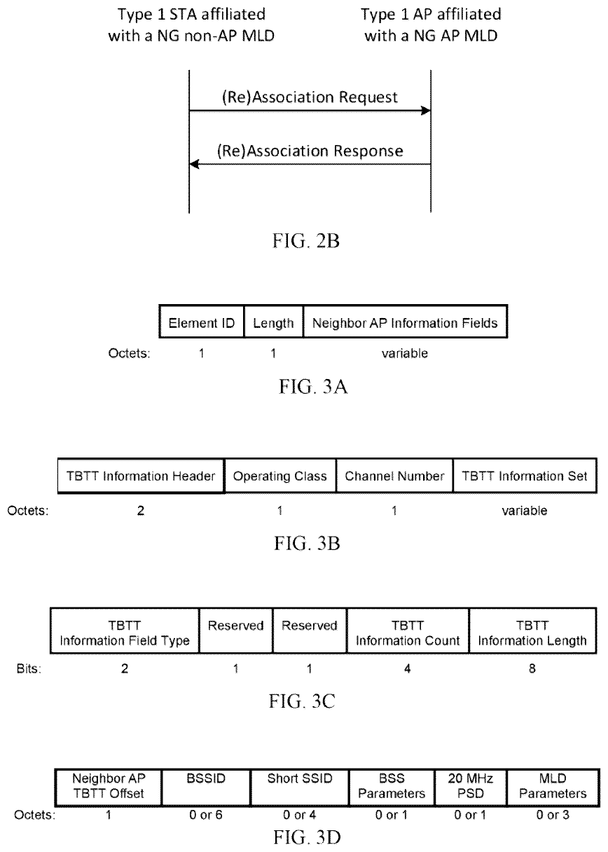

Before a NG non-AP MLD performs a multi-link setup with a NG AP MLD, the NG non-AP MLD makes a discovery of the NG AP MLD in order to obtain capability information and operation parameters of the NG AP MLD. Discovery of a NG AP MLD by a NG non-AP MLD via a Type 2 link may be time consuming since beamforming training may be required between a Type 2 STA affiliated with the NG non-AP MLD and a Type 2 AP affiliated with the NG AP MLD that establish the Type 2 link. In some examples, an AP MLD includes at least one affiliated Type 1 AP and zero or at least one affiliated Type 2 AP. In some examples, an AP MLD includes at least one affiliated Type 1 AP and zero, one, or more affiliated Type 2 APs. In addition, discovery of a NG AP MLD via a Type 1 link may be easy of implementation because it is similar to discovery of a 11be AP MLD. As a result, it may be preferable for discovery of a NG AP MLD via a Type 1 link. FIG. 2A illustrates a procedure for discovery of a NG AP MLD by a NG non-AP MLD via a Type 1 link.

An AP MLD or a non-AP MLD is a logical entity that is capable of supporting more than one affiliated STA but can also operate using one or more affiliated STAs and has one MAC data service and a single MAC SAP to the LLC sublayer where each affiliated STA is a Type 1 STA or a Type 2 STA and at least one affiliated STA is a Type 1 STA. When the AP MLD or non-AP MLD operates using one or more affiliated STAs, the one or more affiliated STAs includes at least one affiliated Type 1 STA. If a Type 1 AP affiliated with a NG AP MLD does not correspond to a non-transmitted BSSID (i.e., if the Type 1 AP affiliated with a NG AP MLD corresponds to a transmitted BSSID in a multiple BSSID set or is not in a multiple BSSID set), a Beacon frame or a Probe Response frame transmitted by the Type 1 AP includes a TBTT Information field in a RNR element with a Neighbor AP TBTT Offset subfield, a BSSID subfield, a Short SSID subfield, a BSS Parameters subfield, a 20 MHz PSD subfield, and an MLD Parameters subfield, for each of other Type 1 APs affiliated with the same NG AP MLD; and includes a TBTT Information field in the RNR element with a Neighbor AP TBTT Offset subfield, a BSSID subfield, a Short SSID subfield, a BSS Parameters subfield, and an MLD Parameters subfield, for each of Type 2 APs affiliated with the same NG AP MLD. The format of the RNR element is illustrated in the following embodiments.

If a Type 1 AP (such as AP1) affiliated with a NG AP MLD (AP MLD 1) corresponds to a non-transmitted BSSID and a Type 1 AP (such as AP3) affiliated with another NG AP MLD (AP MLD2) corresponds to a transmitted BSSID in the same multiple BSSID set as the AP1, a Beacon frame or a Probe Response frame transmitted by the AP3 includes a TBTT Information field in a RNR element with a Neighbor AP TBTT Offset subfield, a BSSID subfield, a Short SSID subfield, a BSS Parameters subfield, a 20 MHz PSD subfield, and an MLD Parameters subfield, for each of other Type 1 APs affiliated with the AP MLD1; and includes a TBTT Information field in the RNR element with a Neighbor AP TBTT Offset subfield, a BSSID subfield, a Short SSID subfield, a BSS Parameters subfield, and an MLD Parameters subfield, for each of Type 2 APs affiliated with the AP MLD1. AP1 can be an example of Type 1 AP. AP3 can be an example of another Type 1 AP. AP3 may be different from AP1.

If all the following conditions are satisfied: i) a Type 1 AP (AP1) affiliated with a NG AP MLD (AP MLD 1) is in the same co-located AP set as APs affiliated with another NG AP MLD (AP MLD 2); ii) the AP MLD 2 has no affiliated APs operating on the same channel as the AP1; and iii) one AP affiliated with the AP MLD 2 is in the same multiple BSSID set as an AP affiliated with the AP MLD 1, then a Beacon frame or a Probe Response frame transmitted by the AP1 includes a TBTT Information field in an RNR element with a Neighbor AP TBTT Offset subfield, a BSSID subfield, a Short SSID subfield, a BSS Parameters subfield, a 20 MHz PSD subfield, and an MLD Parameters subfield for each Type 1 AP of the AP MLD 2; and includes a TBTT Information field in the RNR element with a Neighbor AP TBTT Offset subfield, a BSSID subfield, a Short SSID subfield, a BSS Parameters subfield, a MLD Parameters subfield for each Type 2 AP of the AP MLD 2, unless the APs of the AP MLD 2 are already reported in Beacon frames and Probe Response frames transmitted by an AP in the same co-located AP set as the AP1 and operating on the same channel as the AP1.

If a Type 1 AP affiliated with a NG AP MLD does not correspond to a non-transmitted BSSID (i.e., if the Type 1 AP affiliated with a NG AP MLD corresponds to a transmitted BSSID in a multiple BSSID set or is not in a multiple BSSID set), the Type 1 AP includes, in a Beacon frame or a Probe Response frame, a Basic Multi-Link element for the NG AP MLD. If a Type 1 AP affiliated with a NG AP MLD corresponds to a non-transmitted BSSID in a multiple BSSID set, then a second AP that corresponds to a transmitted BSSID in the same multiple BSSID set includes, in a non-transmitted BSSID profile corresponding to the non-transmitted BSSID in a Beacon frame or a Probe Response frame, a Basic Multi-Link element for the NG AP MLD. The format of the Basic Multi-Link element is defined in following embodiments.

A Common Info field of the Basic Multi-Link element carried in a Beacon frame or a Probe Response frame includes the MLD Capabilities And Operations subfield and may include the Extended MLD Capabilities And Operations subfield. The MLD Capabilities And Operations subfield indicates Type 1 link related capability information of an NG AP MLD, e.g. the Maximum Number Of Simultaneous Type 1 Links subfield of the MLD Capabilities And Operations subfield indicates the maximum number of Type 1 APs affiliated with the NG AP MLD. If the Extended MLD Capabilities And Operations subfield is present in the Common Info field of the Basic Multi-Link element carried in the Beacon frame or Probe Response frame, the Extended MLD Capabilities And Operations subfield indicates Type 2 link related capability information of the NG AP MLD, e.g. the Maximum Number Of Simultaneous Type 2 Links subfield of the Extended MLD Capabilities And Operations subfield indicates the maximum number of Type 2 APs affiliated with the NG AP MLD; and the Link ID Space Boundary subfield of the Extended MLD Capabilities And Operations subfield indicates the boundary between the Type 1 link ID subspace and the Type 2 link ID subspace.

An ML probe request is a Probe Request frame that is sent outside the context of active scanning that is used to discover an AP. An ML probe request includes a Probe Request Multi-Link element and does not include any other variants of Multi-Link element. An ML probe request allows a non-AP STA to request an AP to include the complete or partial set of capabilities, parameters and operation elements of the AP(s) affiliated with the targeted NG AP MLD in an ML probe response. An example format of the Probe Request Multi-Link element is defined in IEEE P802.11be/D1.5. An ML probe response is a Probe Response frame that is transmitted in response to receiving an ML probe request and that includes Basic Multi-Link element which can carry complete or partial per-STA profile(s), based on the soliciting request, for each of the requested AP(s) of the targeted NG AP MLD.

A NG non-AP MLD can discover a NG AP MLD when it receives a Basic Multi-Link element carried in a Beacon frame or Probe Response frame transmitted by a Type 1 AP affiliated with the NG AP MLD or by a Type 1 AP corresponding to a transmitted BSSID in the same multiple BSSID set as at least one of the Type 1 APs affiliated with the NG AP MLD. A NG non-AP MLD can discover a NG AP MLD and the capabilities and operational parameters of one or more APs affiliated with the NG AP MLD when its affiliated Type 1 STA receives an ML probe response from a Type 1 AP affiliated with the NG AP MLD or a Type 1 AP corresponding to a transmitted BSSID in the same multiple BSSID set as at least one of the Type 1 APs affiliated with the NG AP MLD and the ML probe response carries a Basic Multi-Link element with a complete profile of the reported AP.

A NG non-AP MLD can discover an AP (reported AP) as an AP affiliated with a NG AP MLD when its affiliated Type 1 STA receives a Beacon or Probe Response frame transmitted by a Type 1 AP (reporting AP) and the frame carries an RNR element that includes the MLD Parameters subfield in the TBTT Information field corresponding to the reported AP. A NG non-AP MLD can infer the relationship between the reported AP and the reporting AP by decoding the MLD ID subfield of the MLD Parameters subfield in the RNR element. A NG non-AP MLD may use the information it gathers from an RNR element and a Basic Multi-Link element to decide whether to perform multi-link setup with a NG AP MLD.

FIG. 2B illustrates a procedure for multi-link (re) setup between a NG AP MLD and a NG non-AP MLD via a Type 1 link. For a NG non-AP MLD to perform multi-link (re) setup with a NG AP MLD, the NG non-AP MLD and the NG AP MLD can exchange (Re) Association Request/Response frames via a Type 1 link and can follow the MLD (re) association procedure.

In a (Re) Association Request/Response frame exchange for a multi-link setup, both the frames carried Basic Multi-Link element. In the (Re) Association Request frame transmitted by a Type 1 STA affiliated with a NG non-AP MLD, the NG non-AP MLD indicates the links that are requested for (re) setup and the capabilities and operational parameters of the requested links in the Basic Multi-Link element. The NG non-AP MLD may request to (re) set up links with a subset of APs affiliated with the NG AP MLD. The Common Info field of the Basic Multi-Link element carried in the (Re) Association Request frame includes the MLD Capabilities And Operations subfield and may include the Extended MLD Capabilities And Operations subfield. The MLD Capabilities And Operations subfield indicates Type 1 link related capability information of the NG non-AP MLD, e.g., the Maximum Number Of Simultaneous Type 1 Links subfield of the MLD Capabilities And Operations subfield indicates the maximum number of Type 1 STAs affiliated with the NG non-AP MLD that support simultaneous transmission or reception of frames on the respective links; and the Type 1 Frequency Separation For STR subfield of the MLD Capabilities And Operations subfield indicates the minimum frequency gap between any two Type 1 links that is recommended by the non-AP MLD for STR operation. If the Extended MLD Capabilities And Operations subfield is present in the Common Info field of the Basic Multi-Link element carried in the (Re) Association Request frame, the Extended MLD Capabilities And Operations subfield indicates Type 2 link related capability information of the NG non-AP MLD, e.g., the Maximum Number Of Simultaneous Type 2 Links subfield of the Extended MLD Capabilities And Operations subfield indicates the maximum number of Type 2 STAs affiliated with the NG non-AP MLD that support simultaneous transmission or reception of frames on the respective links; and the Type 2 Frequency Separation For STR subfield of the Extended MLD Capabilities And Operations subfield indicates the minimum frequency gap between any two Type 2 links that is recommended by the non-AP MLD for STR operation.

In the (Re) Association Response frame transmitted by a Type 1 AP affiliated with a NG AP MLD, the NG AP MLD can indicate the requested links that are accepted and the requested links that are rejected for (re) setup and the capabilities and operational parameters of the requested links that are accepted. The NG AP MLD may not accept all the links that are requested for (re) setup. The NG AP MLD may accept a subset of the links that are requested for (re) setup. The (Re) Association Response frame can be sent to the non-AP STA affiliated with the NG non-AP MLD that sent the (Re) Association Request frame. The Common Info field of the Basic Multi-Link element carried in the (Re) Association Response frame includes the MLD Capabilities And Operations subfield and may include the Extended MLD Capabilities And Operations subfield. The MLD Capabilities And Operations subfield indicates Type 1 link related capability information of the NG AP MLD, e.g. the Maximum Number Of Simultaneous Type 1 Links subfield of the MLD Capabilities And Operations subfield indicates the maximum number of Type 1 APs affiliated with the NG AP MLD. If the Extended MLD Capabilities And Operations subfield is present in the Common Info field of the Basic Multi-Link element carried in the (Re) Association Response frame, the Extended MLD Capabilities And Operations subfield indicates Type 2 link related capability information of the NG AP MLD, e.g. the Maximum Number Of Simultaneous Type 2 Links subfield of the Extended MLD Capabilities And Operations subfield indicates the maximum number of Type 2 APs affiliated with the NG AP MLD; and the Link ID Space Boundary subfield of the Extended MLD Capabilities And Operations subfield indicates the boundary between the Type 1 link ID subspace and the Type 2 link ID subspace.

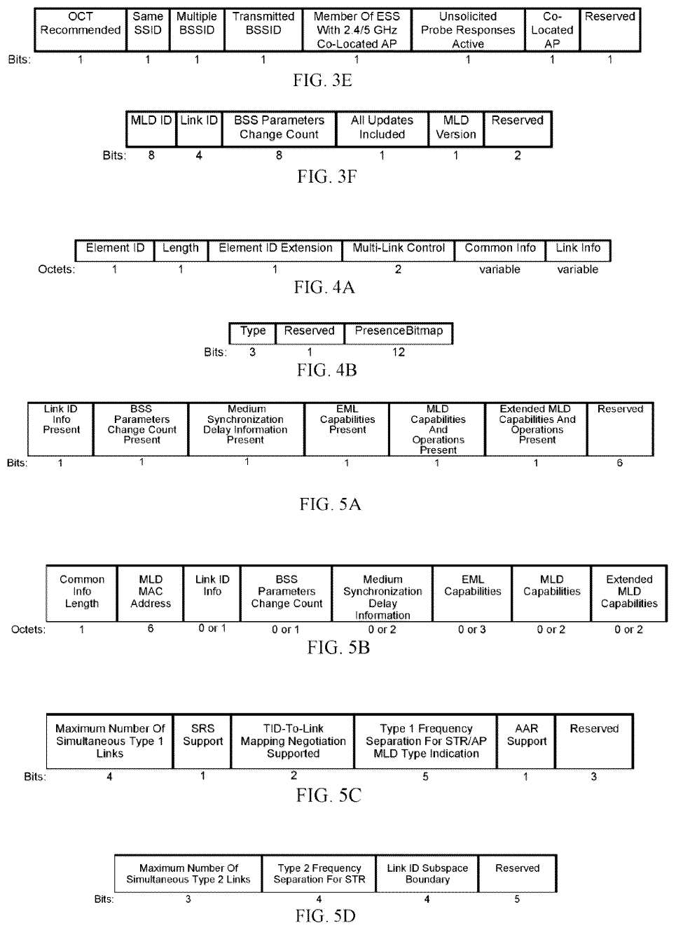

The RNR element described in FIG. 3A includes a Neighbor AP Information Fields field, which contains one or more of the Neighbor AP Information field described in FIG. 3B.

The Neighbor AP Information field comprises a TBTT Information Header subfield, an Operating Class subfield, a Channel Number subfield, and a TBTT Information Set subfield. The TBTT Information Set subfield comprises one or more of TBTT Information fields that specify TBTT and other information related to a group of neighbor APs on one channel specified in the Operating Class subfield and the Channel Number subfield. The format of TBTT Information Header subfield of the Neighbor AP Information field is defined in FIG. 3C.

The TBTT Information Count subfield contains the number of TBTT Information fields included in the TBTT Information Set subfield minus one. If the TBTT Information Field Type subfield is 1, the TBTT Information Length subfield is set to 3 and each TBTT Information field comprises a 3-octet MLD Parameters subfield. If the TBTT Information Field Type subfield is 0, the TBTT Information Length subfield indicates the length and contents of each TBTT Information field described in FIG. 3D; and is interpreted as shown in Table 1. For example, when the TBTT Information Length subfield value is 15, each TBTT Information field comprises a 1-octet Neighbor AP TBTT Offset subfield, a 6-octet BSSID subfield, a 4-octet Short SSID subfield, 1-octet BSS Parameters subfield, and a 3-octet MLD Parameters subfield.

TABLE 1

| TBTT Information | |
|---|---|
| Length subfield | |
| value | TBTT Information field contents |
| 1 | The Neighbor AP TBTT Offset subfield |
| 2 | The Neighbor AP TBTT Offset subfield and the |
| | BSS Parameters subfield |
| 5 | The Neighbor AP TBTT Offset subfield and the |
| | Short SSID subfield |
| 6 | The Neighbor AP TBTT Offset subfield, the |
| | Short SSID subfield, and the |
| | BSS Parameters subfield |
| 7 | The Neighbor AP TBTT Offset subfield and the |
| | BSSID subfield |
| 8 | The Neighbor AP TBTT Offset subfield, the |
| | BSSID subfield, and the |
| | BSS Parameters subfield |
| 9 | The Neighbor AP TBTT Offset subfield, the |
| | BSSID subfield, the BSS |
| | Parameters subfield, and the 20 MHz PSD |
| | subfield |
| 11 | The Neighbor AP TBTT Offset subfield, the |
| | BSSID subfield and the |
| | Short SSID subfield |
| 12 | The Neighbor AP TBTT Offset subfield, the |
| | BSSID subfield, the Short |
| | SSID subfield, and the BSS Parameters subfield |
| 0, 3, 4, 10, 14 | Reserved |
| 13 | The Neighbor AP TBTT Offset subfield, the |
| | BSSID subfield, the Short |
| | SSID subfield, the BSS Parameters subfield, |
| | and the 20 MHz PSD |
| | subfield |
| 15 | The Neighbor AP TBTT Offset subfield, the |
| | BSSID subfield, the Short |
| | SSID subfield, the BSS Parameters subfield, |
| | and the MLD Parameters |
| | subfield |
| 16 | The Neighbor AP TBTT Offset subfield, the |
| | BSSID subfield, the Short |
| | SSID subfield, the BSS Parameters subfield, |
| | the 20 MHz PSD subfield |
| | and the MLD Parameters subfield |
| 17-255 | The first 16 octets of the field contain |
| | the Neighbor AP TBTT Offset |
| | subfield, the BSSID subfield, the Short |
| | SSID subfield, the BSS |
| | Parameters subfield, the 20 MHz PSD |
| | subfield and the MLD Parameters |
| | subfield (i.e., same contents as when the |
| | length of the TBTT Information |
| | field is 16). The remaining octets are |
| | reserved |

The TBTT Information Set subfield of the Neighbor AP Information field contains one or more of the TBTT Information field described in FIG. 3D. The Neighbor AP TBTT Offset field, the BSSID field, and the Short SSID field are defined in IEEE P802.11-REVme/D1.2.

The format of the BSS Parameters subfield is shown in FIG. 3E. The OCT Recommended field, the Member Of ESS With 2.4/5 GHZ Co-Located AP field, and the Unsolicited Probe Responses Active field are reserved if the reported AP is a Type 2 AP. The OCT Recommended field, the Member Of ESS With 2.4/5 GHZ Co-Located AP field, and the Unsolicited Probe Responses Active field are defined in IEEE P802.11-REVme/D1.2, if the reported AP is a Type 1 AP. The Same SSID subfield is set to 1 to indicate that the reported AP has the same SSID as the reporting AP. It is set to 0 otherwise. The Multiple BSSID subfield is set to 1 to indicate that the reported AP is part of a multiple BSSID set. It is set to 0 otherwise. The Transmitted BSSID subfield is set to 1 to indicate that the reported AP is a transmitted BSSID. It is set to 0 if the reported AP is a non-transmitted BSSID. It is reserved if the Multiple BSSID subfield is set to 0. The Co-Located AP subfield is set to 1 if every AP in this Neighbor AP Information field is in the same co-located AP set as the transmitting AP. It is set to 0 otherwise.

The format of the MLD Parameters subfield is defined in FIG. 3F. The MLD ID subfield, the Link ID subfield and the All Updates Included subfield are defined in IEEE P802.11be/D1.5.

The BSS Parameters Change Count subfield is an unsigned integer, initialized to 0, that increments when a critical update to the BSS parameters of the reported AP occurs. The BSS Parameters Change Count subfield is set to 255 if the reported AP is not part of an AP MLD, or if the reporting AP does not have that information. The critical updates to the BSS parameters of the reported Type 1 AP are defined in IEEE P802.11be/D1.5. The critical updates to the BSS Parameters of the reported Type 2 AP include: Modification of the EDCA Parameter Set element, Modification of the DMG Operation element, Modification of the EDMG Operation element, Inclusion of a Quiet element, Inclusion of a DMG BSS Parameter Change element, and/or Inclusion of an Extended Channel Switch Announcement element. Modification of an element means that at least one value of a field in the element is changed. Inclusion of an element means that the element is included in a DMG Beacon frame. The MLD Version subfield indicates a version of the AP MLD with which the reported AP is affiliated. It is set to 0 if the AP MLD with which the reported AP is affiliated is an 11be AP MLD; and set to 1 if the AP MLD with which the reported AP is affiliated is a NG AP MLD; or vice versa.

The format of the Multi-Link element is defined in FIG. 4A.

The format of the Multi-Link Control field of the Multi-Link element is defined in FIG. 4B. The Type subfield has a common encoding for all variants of the Multi-Link element and is used to differentiate the variants of the Multi-Link element. For example, the Type subfield is set to 0 to indicate Basic Multi-Link element; and set to 1 to indicate Probe Request Multi-Link element. The Presence Bitmap subfield is used to indicate the presence of various subfields in the Common Info field and has different format for different variants of the Multi-Link element.

The format of the Presence Bitmap subfield of the Basic Multi-Link element is defined in FIG. 5A. The Presence Bitmap subfield is used to indicate the presence of various subfields in the Common Info field and has different format for different variants of the Multi-Link element.

The MLD Capabilities And Operations Present subfield indicates the presence of the MLD Capabilities And Operations subfield in the Common Info field. The MLD Capabilities And Operations Present subfield is set to 1 if the MLD Capabilities And Operations subfield is present in the Common Info field. Otherwise, the MLD Capabilities And Operations Present subfield is set to 0. The Extended MLD Capabilities And Operations Present subfield indicates the presence of the Extended MLD Capabilities And Operations subfield in the Common Info field. The Extended MLD Capabilities And Operations Present subfield is set to 1 if the Extended MLD Capabilities And Operations subfield is present in the Common Info field. Otherwise, the Extended MLD Capabilities And Operations Present subfield is set to 0. If the Extended MLD Capabilities And Operations Present subfield is set to 1, the MLD Capabilities And Operations Present subfield can be set to 1.

The format of the Common Info field of the Basic Multi-Link element is defined in FIG. 5B. The Common Info field carries information that is common to all the links except for Link ID Info subfield and BSS Parameters Change Count subfield that are for the link on which the Multi-Link element is sent.

The format of the MLD Capabilities And Operations field is shown in FIG. 5C. The Maximum Number Of Simultaneous Type 1 Links subfield of the MLD Capabilities And Operations field indicates the maximum number of Type 1 STAs affiliated with the MLD that support simultaneous transmission or reception of frames on the respective links. For a non-AP MLD, the Maximum Number Of Simultaneous Type 1 Links subfield is set to the maximum number of Type 1 STAs affiliated with the non-AP MLD that support simultaneous transmission or reception of frames minus 1. For an AP MLD, the Maximum Number Of Simultaneous Type 1 Links subfield is set to the number of affiliated Type 1 APs minus 1. The Type 1 Frequency Separation For STR subfield of the MLD Capabilities And Operations field indicates the minimum frequency gap between any two Type 1 links that is recommended by the non-AP MLD for STR operation. The frequency gap is specified as the difference between the nearest frequency edges of the two links. The Type 1 Frequency Separation For STR subfield is set to 0 to indicate that no frequency separation information is provided; and set to a nonzero value n to indicate that the STR frequency gap is (n−1)×80 MHZ.

The format of the Extended MLD Capabilities And Operations field is illustrated in FIG. 5D. The Maximum Number Of Simultaneous Type 2 Links subfield of the Extended MLD Capabilities And Operations field indicates the maximum number of Type 2 STAs affiliated with the MLD that support simultaneous transmission or reception of frames on the respective links. For a non-AP MLD, the Maximum Number Of Simultaneous Type 2 Links subfield is set to the maximum number of Type 2 STAs affiliated with the non-AP MLD that support simultaneous transmission or reception of frames minus 1. For an AP MLD, the Maximum Number Of Simultaneous Type 2 Links subfield is set to the number of affiliated Type 2 APs minus 1. The Type 2 Frequency Separation For STR subfield of the Extended MLD Capabilities And Operations field indicates the minimum frequency gap between any two Type 2 links that is recommended by the non-AP MLD for STR operation. The Type 2 Frequency Separation For STR subfield is set to 0 to indicate that no frequency separation information is provided; and set to a nonzero value n to indicate that the STR frequency gap is (n−1)×2.16 GHz.

Link ID space for an MLD is divided into two subspaces: Type 1 link ID subspace followed by Type 2 link ID subspace. The Link ID Subspace Boundary subfield of the Extended MLD Capabilities And Operations field indicates the boundary between the Type 1 link ID subspace and the Type 2 link ID subspace. The Link ID Subspace Boundary subfield may be set to the maximum Type 1 link ID minus 1. In an example, if the maximum Type 1 link ID in the MLD is 8, the Link ID Subspace Boundary subfield is set to 7. In this case, the Type 2 link ID subspace in the MLD is [8 15]. In another example, if the maximum Type 1 link ID in the MLD is 16, the Link ID Subspace Boundary subfield is set to 15. In this case, there is no any Type 2 link in the MLD.

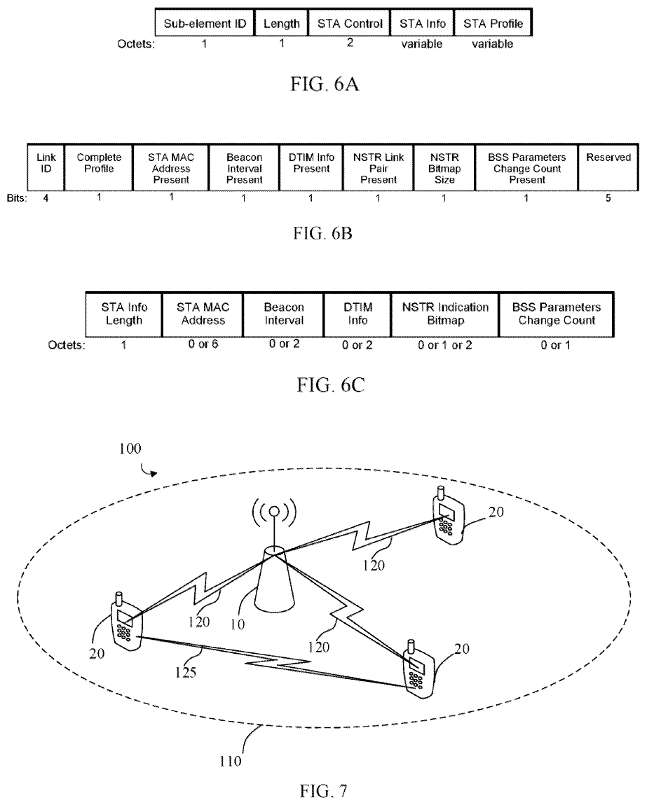

The Link Info field may include one or more Per-STA Profile sub-elements. The format of a Per-STA Profile sub-element is defined in FIG. 6A. The format of the STA Control field is defined in FIG. 6B.

The Link ID subfield in the STA Control field specifies a value that uniquely identifies the link where the reported STA is operating on. The NSTR Link Pair Present subfield in the STA Control field indicates if at least one NSTR link pair is present in the MLD that contains the link corresponding to that STA. The NSTR Link Pair Present subfield is set to 1 if there is at least one such link pair; or otherwise, it is set to 0. If the NSTR Link Pair Present subfield is equal to 1 in the STA Control field, then the STA Info field contains a NSTR Indication Bitmap subfield whose size is indicated in the NSTR Bitmap Size subfield; otherwise, the NSTR Indication Bitmap subfield is not present in the STA Info field.

The format of the STA Info field is defined in FIG. 6C. Each bit Bⱼ(j≠i) in the NSTR Indication Bitmap subfield included in the Per-STA Profile sub-element with Link ID subfield equals to i (where 0≤i<15) is set to 1 if the link pair corresponding to link IDs equal to <i, j> is NSTR and the Basic Multi-Link element contains a Per-STA Profile sub-element with Link ID value equals to j; or otherwise, it is set to 0. Bit Bᵢ in the NSTR Indication Bitmap subfield included in the Per-STA Profile sub-element with Link ID subfield value equals to i is reserved. A link pair of one Type 1 link and one Type 2 link is a STR link pair due to huge frequency separation between them. As a result, for a Per-STA Profile sub-element corresponding to a Type 1 link, each bit corresponding to a Type 2 link in the NSTR Indication Bitmap subfield included in the Per-STA Profile sub-element is set to 0. Similarly, for a Per-STA Profile sub-element corresponding to a Type 2 link, each bit corresponding to a Type 1 link in the NSTR Indication Bitmap subfield included in the Per-STA Profile sub-element is set to 0.

Various embodiments are described. It is understood that the present disclosure is not limited in any way to the embodiments that are represented in the description and the drawings. Many variations and combinations of embodiments are possible within the framework of the present disclosure. Combinations of one or more aspects of the embodiments or combinations of different embodiments are possible within the framework of the present disclosure. All comparable variations are understood to fall within the framework of the present disclosure.

FIG. 7 illustrates an example of a wireless communications system according to an embodiment of the present disclosure. The wireless communications system may be an example of a WLAN 100 (also known as a Wi-Fi network) (such as next generation, next big thing (NBT), ultra-high throughput (UHT) Wi-Fi network) configured in accordance with various aspects of the present disclosure. As described herein, the terms next generation, NBT, and UHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not illustrated) associated with the WLAN 100 may be connected to a wired or wireless distribution system that may allow multiple APs 10 to be connected in an ESS or a VBSS.

In some embodiments, a STA 20 may be located in the intersection of more than one coverage area 110 and may associate with more than one AP 10. A single AP 10 and an associated set of STAs 20 may be referred to as a BSS. An ESS or a VBSS is a set of connected BSSs. A distribution system (not illustrated) may be used to connect APs 10 in an ESS or a VBSS. In some cases, the coverage area 110 of an AP 10 may be divided into sectors (also not illustrated). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 120 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11 g, 802.11a, 802.11n, 802.11ac, 802.11ad, 802.11ah, 802.11ax, 802.11be, 802.11ay, etc. In some other implementations, peer-to-peer connections or ad hoc networks may be implemented within the WLAN 100.

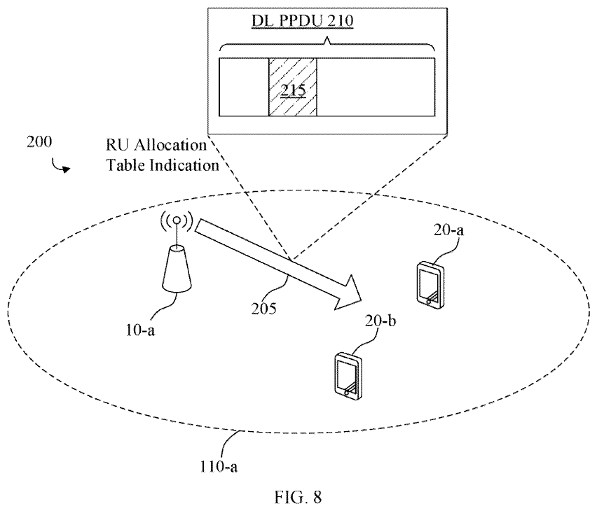

FIG. 8 illustrates an example of a wireless communications system according to another embodiment of the present disclosure. The wireless communications system 200 may be an example of a next generation or UHT Wi-Fi system and may include an AP 10-a and STAs 20-a and 20-b, and a coverage area 110-a, which may be examples of components described with respect to FIG. 8. The AP 10-a may transmit a DL PPDU 210 (e.g., UHT MU PPDU) including an RU allocation table indication 215 on the downlink 205 to the STAs 20.

In some implementations, a wireless communications system 200 may be a next generation Wi-Fi system (such as, a UHT system). In some implementations, wireless communications system 200 may also support multiple communications systems. For instance, wireless communications system 200 may support UHT communications and EHT communications. In some implementations, the STA 20-a and the STA 20-b may be different types of STAs. For example, the STA 20-a may be an example of a UHT STA, while the STA 20-b may be an example of an EHT STA. The STA 20-b may be referred to as a legacy STA.

In some instances, UHT communications may support higher modulations than legacy communications. For instance, UHT communications may support 16K quadrature amplitude modulation (QAM), whereas legacy communications may support 4K QAM. UHT communications may support a larger number of spatial streams than legacy systems. In one non-limiting illustrative example, UHT communications may support 16 spatial streams, whereas legacy communications may support 8 spatial streams. In some cases, UHT communications may occur a 2.4 GHz channel, a 5 GHz channel, or a 6 GHz channel in unlicensed spectrum.

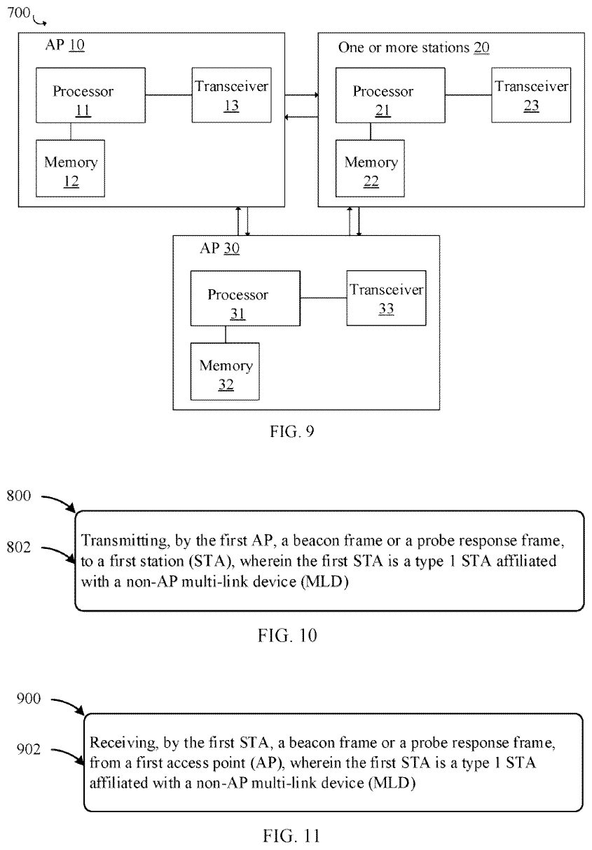

FIG. 9 illustrates one or more STAs 20, an AP 10, and an AP 30 of communication in a wireless communications system 700 according to an embodiment of the present disclosure. FIG. 9 illustrates that, the wireless communications system 700 includes an AP 10, an AP 30 and one or more STAs 20. The AP 10 may include a memory 12, a transceiver 13, and a processor 11 coupled to the memory 12, the transceiver 13. The AP 30 may include a memory 32, a transceiver 33, and a processor 31 coupled to the memory 32, the transceiver 33. The one or more STAs 20 may include a memory 22, a transceiver 23, and a processor 21 coupled to the memory 22, the transceiver 23. The processor 11, 21 or 31 may be configured to implement proposed functions, procedures and/or methods described in this description. Layers of radio interface protocol may be implemented in the processor 11, 21 or 31. The memory 12, 22 or 32 is operatively coupled with the processor 11, 21 or 31 and stores a variety of information to operate the processor 11, 21 or 31. The transceiver 13, 23 or 33 is operatively coupled with the processor 11, 21 or 31, and the transceiver 13, 23 or 33 transmits and/or receives a radio signal.

The processor 11, 21 or 31 may include application-specific integrated circuit (ASIC), other chipset, logic circuit and/or data processing device. The memory 12, 22 or 32 may include read-only memory (ROM), random access memory (RAM), flash memory, memory card, storage medium and/or other storage device. The transceiver 13, 23 or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22 or 32 and executed by the processor 11, 21 or 31. The memory 12, 22 or 32 can be implemented within the processor 11, 21 or 31 or external to the processor 11, 21 or 31 in which case those can be communicatively coupled to the processor 11, 21 or 31 via various means as is known in the art.

In some embodiments, the transceiver 13 or 33 is configured to transmit, to the STA 20 (such as a first STA), a beacon frame or a probe response frame, wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

In some embodiments, the transceiver 23 is configured to receive a beacon frame or a probe response frame from a first access point (AP) (such as the AP 10), wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

In a first clause, the embodiments of the present disclosure provide a wireless communication method by a first station (STA), which includes:
receiving, by the first STA, a beacon frame or a probe response frame, from a first access point (AP), where the first STA is a type 1 STA affiliated with a non-AP multi-link device (MLD).

In a second clause, in the wireless communication method of the first clause, the first AP is a type 1 AP affiliated with an AP MLD that has zero or at least one affiliated type 2 AP.

In a third clause, in the wireless communication method in the second clause, the AP MLD is a logical entity that has one MAC data service and a single MAC SAP to a LLC sublayer; and the AP MLD is capable of supporting more than one affiliated AP, and/or operates using one or more affiliated APs where each affiliated AP is the type 1 AP or the type 2 AP and at least one affiliated AP is the type 1 AP.

In a fourth clause, in the wireless communication method in the second clause, the first STA affiliated with the non-AP MLD transmits an association request frame or a reassociation request frame to a third AP.

In a fifth clause, in the wireless communication method in the first clause or the second clause, the beacon frame or the probe response frame includes a target beacon transmission time (TBTT) information field, a multi-link control field, and/or a common information field.

In a sixth clause, in the wireless communication method in the fifth clause, if the first AP corresponds to a transmitted basic service set identifier (BSSID) in a multiple BSSID set or is not in a multiple BSSID set, the beacon frame or the probe response frame includes the TBTT information field, for each of type 2 APs affiliated with the AP MLD or for each of other type 1 APs affiliated with the same AP MLD.

In a seventh clause, in the wireless communication method in the sixth clause, an MLD version subfield of the MLD parameters subfield indicates a version of the AP MLD with which the reported AP is affiliated.

In an eighth clause, in the wireless communication method in the sixth clause, the TBTT information field for each type 2 AP includes a neighbor AP TBTT offset subfield, a BSSID subfield, a short SSID subfield, a BSS parameters subfield, and an MLD parameters subfield.

In a ninth clause, in the wireless communication method in the fifth clause, if the first AP corresponds to a transmitted BSSID in a multiple BSSID set or is not in a multiple BSSID set, the beacon frame or the probe response frame includes the multi-link control field and the common information field in a basic multi-link element.

In a tenth clause, in the wireless communication method in the ninth clause, a link ID subspace boundary subfield of an extended MLD capabilities and operations field indicates a boundary between a type 1 link ID subspace and a type 2 link ID subspace, and/or the link ID subspace boundary subfield is set to a maximum type 1 link ID minus 1.

In an eleventh clause, in the wireless communication method in the fourth clause, the third AP is the first AP or a type 1 AP affiliated with another AP MLD and operating at the same link as the first STA.

In a twelfth clause, in the wireless communication method in the fourth clause or the eleventh clause, the association request frame or the reassociation request frame includes a multi-link control field, a common information field, and a link information field in a basic multi-link element.

In a thirteenth clause, in the wireless communication method in the twelfth clause, an extended MLD capabilities and operations present subfield of the multi-link control field indicates a presence of an extended MLD capabilities and operations subfield in the common information field.

In a fourteenth clause, in the wireless communication method in the twelfth clause, when an extended MLD capabilities and operations subfield is present in the common information field, an MLD capabilities and operations subfield is also present in the common information field.

In a fifteenth clause, in the wireless communication method in the twelfth clause, a maximum number of simultaneous type 1 link subfield of an MLD capabilities and operations field indicates a maximum number of type 1 STAs affiliated with the MLD that support simultaneous transmission or reception of frames on respective links; and/or is set to the maximum number of type 1 STAs affiliated with the non-AP MLD that support simultaneous transmission or reception of frames minus 1.

In a sixteenth clause, in the wireless communication method in the twelfth clause, a maximum number of simultaneous type 2 link subfield of an extended MLD capabilities and operations field indicates a maximum number of type 2 STAs affiliated with the MLD that support simultaneous transmission or reception of frames on respective links; and/or is set to the maximum number of type 2 STAs affiliated with the non-AP MLD that support simultaneous transmission or reception of frames minus 1.

In a seventeenth clause, in the wireless communication method in the twelfth clause, a type 1 frequency separation for simultaneous transmit and receive (STR) subfield of an MLD capabilities and operations field indicates a minimum frequency gap between any two type 1 links that is recommended by the non-AP MLD for STR operation; and/or is set to 0 to indicate that no frequency separation information is provided; and/or set to a nonzero value n to indicate that a STR frequency gap is (n−1)×80 MHz.

In an eighteenth clause, in the wireless communication method in the twelfth clause, a type 2 frequency separation for STR subfield of an extended MLD capabilities and operations field indicates a minimum frequency gap between any two type 2 links that is recommended by the non-AP MLD for STR operation; and/or is set to 0 to indicate that no frequency separation information is provided; and/or set to a nonzero value n to indicate that a STR frequency gap is (n−1)×2.16 GHz.

In a nineteenth clause, in the wireless communication method in the twelfth clause, a per-STA profile sub-element of the link information field includes a non-simultaneous transmit and receive (NSTR) indication bitmap subfield in a STA information field.

In a twentieth clause, in the wireless communication method in the nineteenth clause, if the per-STA profile sub-element corresponds to a type 1 link, each bit corresponding to a type 2 link in the NSTR indication bitmap subfield is set to 0.

In a twenty-first clause, in the wireless communication method in the nineteenth clause, if the per-STA profile sub-element corresponds to a type 2 link, each bit corresponding to a type 1 link in the NSTR indication bitmap subfield is set to 0.

In a twenty-second clause, in the wireless communication method in the second clause, the AP MLD is a next generation (NG) AP MLD, and a discovery of the NG AP MLD is via a type 1 link.

In a twenty-third clause, in the wireless communication method in the eighth clause, the TBTT information field for each type 2 AP includes a 1-octet neighbor AP TBTT offset subfield, a 6-octet BSSID subfield, a 4-octet short SSID subfield, a 1-octet BSS parameters subfield, and a 3-octet MLD parameters subfield.

In a twenty-fourth clause, in the wireless communication method in the seventh clause, the MLD version subfield of the MLD parameters subfield is set to 0 if the AP MLD with which the reported AP is affiliated is an 11be AP MLD; and/or set to 1 if the AP MLD with which the reported AP is affiliated is a NG AP MLD.

In a twenty-fifth clause, in the wireless communication method in the seventh clause, the MLD version subfield of the MLD parameters subfield is set to 1 if the AP MLD with which the reported AP is affiliated is an 11be AP MLD; and/or set to 0 if the AP MLD with which the reported AP is affiliated is a NG AP MLD.

In a twenty-sixth clause, in the wireless communication method in the thirteenth clause, the extended MLD capabilities and operations present subfield is set to 1 if the extended MLD capabilities and operations subfield is present in the common information field; or otherwise, the extended MLD capabilities and operations present subfield is set to 0.

In a twenty-seventh clause, in the wireless communication method in the thirteenth clause, if the extended MLD capabilities and operations present subfield is set to 1, the MLD capabilities and operations present subfield is set to 1.

In a twenty-eighth clause, in the wireless communication method in the first clause, the non-AP MLD is a logical entity that has one MAC data service and a single MAC SAP to a logical link control (LLC) sublayer; and the non-AP MLD is capable of supporting more than one affiliated STA, and/or operates using one or more affiliated STAs where each affiliated STA is the type 1 STA or the type 2 STA and at least one affiliated STA is the type 1 STA.

In a twenty-ninth clause, in the wireless communication method in the twenty-eighth clause, when the non-AP MLD operates using one or more affiliated STAs, the one or more affiliated STAs includes at least one affiliated type 1 STA.

In a thirtieth clause, in the wireless communication method in the third clause, when the AP MLD operates using one or more affiliated APs, the one or more affiliated APs includes at least one affiliated type 1 AP.

In a thirty-first clause, the embodiments of the present disclosure provide a wireless communication method by a first access point (AP), which includes:
transmitting, by the first AP, a beacon frame or a probe response frame, to a first station (STA), where the first STA includes a type 1 STA affiliated with a non-AP multi-link device (MLD).

In a thirty-second clause, in the wireless communication method in the thirty-first clause, the first AP is a type 1 AP affiliated with an AP MLD that has zero or at least one affiliated type 2 AP.

In a thirty-third clause, in the wireless communication method in the thirty-first clause or the thirty-second clause, the beacon frame or the probe response frame includes a target beacon transmission time (TBTT) information field, a multi-link control field, and/or a common information field.

In a thirty-fourth clause, in the wireless communication method in the thirty-third clause, if the first AP corresponds to a transmitted basic service set identifier (BSSID) in a multiple BSSID set or is not in a multiple BSSID set, the beacon frame or the probe response frame includes the TBTT information field for each of type 2 APs affiliated with the AP MLD or for each of other type 1 APs affiliated with the same AP MLD.

In a thirty-fifth clause, in the wireless communication method in the thirty-fourth clause, the TBTT information field is in a reduced neighbor report (RNR) element with a neighbor AP TBTT offset subfield, a BSSID subfield, a short service set identifier (SSID) subfield, a basic service set (BSS) parameters subfield, and/or an MLD parameters subfield.

In a thirty-sixth clause, in the wireless communication method in the thirty-third clause, if second AP affiliated with another AP MLD corresponds to a non-transmitted SSID and the first AP corresponds to a transmitted BSSID in a same multiple BSSID set as the second AP, the beacon frame or the probe response frame includes the TBTT information field for each of type 2 APs affiliated with the other AP MLD or for each of other type 1 APs affiliated with the AP MLD.

In a thirty-seventh clause, in the wireless communication method in the thirty-sixth clause, the TBTT information field is in an RNR element with a neighbor AP TBTT offset subfield, a BSSID subfield, a short SSID subfield, a BSS parameters subfield, and/or an MLD parameters subfield.

In a thirty-eighth clause, in the wireless communication method in the thirty-third clause, if the first AP is in a same co-located AP set as APs affiliated with another AP MLD, the other AP MLD has no affiliated APs operating on a same channel as the first AP, and one AP affiliated with the other AP MLD is in a same multiple BSSID set as an AP affiliated with the AP MLD, the beacon frame or the probe response frame includes the TBTT information field in an RNR element with a neighbor AP TBTT offset subfield, a BSSID subfield, a short-BSSID subfield, a BSS parameters subfield, a 20 MHz power spectral density (PSD) subfield, and/or an MLD parameters subfield for each type 1 AP of the other AP MLD, and/or the beacon frame or the probe response frame includes the TBTT Information field in the RNR element with the neighbor AP TBTT offset subfield, the BSSID subfield, the short-BSSID subfield, the BSS parameters subfield, and/or the MLD parameters subfield for each type 2 AP of the other AP MLD.

In a thirty-ninth clause, in the wireless communication method in any one of the thirty-fourth clause to the thirty-eighth clause, fields of the BSS parameters subfield are reserved if a reported AP is the type 2 AP.

In a fortieth clause, in the wireless communication method in the thirty-ninth clause, the fields of the BSS parameters subfield include an on-channel tunneling (OCT) recommended field, a member of extended service set (ESS) with 2.4/5 GHz co-located AP field, and an unsolicited probe response active field.

In a forty-first clause, in the wireless communication method in any one of the thirty-fifth clause to the thirty-eighth clause, an MLD version subfield of the MLD parameters subfield indicates a version of the AP MLD with which the reported AP is affiliated.

In a forty-second clause, in the wireless communication method in any one of the thirty-sixth clause to the thirty-eighth clause, a BSS parameter change count subfield of the MLD parameters subfield is an unsigned integer and is initialized to 0, that increments when a critical update to a BSS parameter of the reported AP occurs.

In a forty-third clause, in the wireless communication method in the forty-second clause, if the reported AP is the type 2 AP, the critical update to the BSS parameter of the reported AP includes a modification of an enhanced distributed channel access (EDCA) parameter set element, a modification of a directional multi-gigabit (DMG) operation element, a modification of an enhanced directional multi-gigabit (EDMG) operation element, an inclusion of a quiet element, an inclusion of a DMG BSS parameter change element, and/or an inclusion of an extended channel switch announcement element.

In a forty-fourth clause, in the wireless communication method in the thirty-fourth clause, if the first AP corresponds to a transmitted BSSID in a multiple BSSID set or is not in a multiple BSSID set, the beacon frame or the probe response frame includes the multi-link control field and the common information field in a basic multi-link element.

In a forty-fifth clause, in the wireless communication method in the forty-fourth clause, an extended MLD capabilities and operations present subfield of the multi-link control field indicates a presence of an extended MLD capabilities and operations subfield in the common information field.

In a forty-sixth clause, in the wireless communication method in the forty-fourth clause, when an extended MLD capabilities and operations subfield is present in the common information field, an MLD capabilities and operations subfield is also present in the common information field.

In a forty-seventh clause, in the wireless communication method in the forty-fourth clause, a maximum number of simultaneous type 1 link subfield of an MLD capabilities and operations field indicates a maximum number of type 1 STAs affiliated with the MLD that support simultaneous transmission or reception of frames on respective links; and/or is set to a number of affiliated type 1 APs minus 1.

In a forty-eighth clause, in the wireless communication method in the forty-fourth clause, a maximum number of simultaneous type 2 link subfield of an extended MLD capabilities and operations field indicates a maximum number of type 2 STAs affiliated with the MLD that support simultaneous transmission or reception of frames on respective links; and/or is set to a number of affiliated type 2 APs minus 1.

In a forty-ninth clause, in the wireless communication method in a forty-fourth clause, in a link ID subspace boundary subfield of an extended MLD capabilities and operations field indicates a boundary between a type 1 link ID subspace and a type 2 link ID subspace, and/or the link ID subspace boundary subfield is set to a maximum type 1 link ID minus 1.

In a fiftieth clause, in the wireless communication method in the thirty-second clause, the first STA affiliated with the non-AP MLD transmits an association request frame or a reassociation request frame to a third AP.

In a fifty-first clause, in the wireless communication method in the fiftieth clause, the third AP is the first AP or a type 1 AP affiliated with another AP MLD and operating at the same link as the first STA.

In a fifty-second clause, in the wireless communication method in the fiftieth clause or the fifty-first clause, the association request frame or the reassociation request frame includes a multi-link control field, a common information field, and a link information field in a basic multi-link element.

In a fifty-third clause, in the wireless communication method in the fifty-second clause, an extended MLD capabilities and operations present subfield of the multi-link control field indicates a presence of an extended MLD capabilities and operations subfield in the common information field.

In a fifty-fourth clause, in the wireless communication method in the fifty-second clause, when an extended MLD capabilities and operations subfield is present in the common information field, an MLD capabilities and operations subfield is also present in the common information field.

In a fifty-fifth clause, in the wireless communication method in the fifty-second clause, a maximum number of simultaneous type 1 link subfield of an MLD capabilities and operations field indicates a maximum number of type 1 STAs affiliated with the MLD that support simultaneous transmission or reception of frames on respective links; and/or is set to the maximum number of type 1 STAs affiliated with the non-AP MLD that support simultaneous transmission or reception of frames minus 1.

In a fifty-sixth clause, in the wireless communication method in the fifty-second clause, a maximum number of simultaneous type 2 link subfield of an extended MLD capabilities and operations field indicates a maximum number of type 2 STAs affiliated with the MLD that support simultaneous transmission or reception of frames on respective links; and/or is set to the maximum number of type 2 STAs affiliated with the non-AP MLD that support simultaneous transmission or reception of frames minus 1.

In a fifty-seventh clause, in the wireless communication method in the fifty-second clause, a type 1 frequency separation for simultaneous transmit and receive (STR) subfield of an MLD capabilities and operations field indicates a minimum frequency gap between any two type 1 links that is recommended by the non-AP MLD for STR operation; and/or is set to 0 to indicate that no frequency separation information is provided; and/or set to a nonzero value n to indicate that a STR frequency gap is (n−1)×80 MHz.

In a fifty-eighth clause, in the wireless communication method in the fifty-second clause, a type 2 frequency separation for STR subfield of an extended MLD capabilities and operations field indicates a minimum frequency gap between any two type 2 links that is recommended by the non-AP MLD for STR operation; and/or is set to 0 to indicate that no frequency separation information is provided; and/or set to a nonzero value n to indicate that a STR frequency gap is (n−1)×2.16 GHZ.

In a fifty-ninth clause, in the wireless communication method in the fifty-second clause, a per-STA profile sub-element of the link information field includes a non-simultaneous transmit and receive (NSTR) indication bitmap subfield in a STA information field.

In a sixtieth clause, in the wireless communication method in the fifty-ninth clause, if the per-STA profile sub-element corresponds to a type 1 link, each bit corresponding to a type 2 link in the NSTR indication bitmap subfield is set to 0.

In a sixty-first clause, in the wireless communication method in the fifty-ninth clause, if the per-STA profile sub-element corresponds to a type 2 link, each bit corresponding to a type 1 link in the NSTR indication bitmap subfield is set to 0.

In a sixty-second clause, in the wireless communication method in the thirty-second clause, the AP MLD is a next generation (NG) AP MLD, and a discovery of the NG AP MLD is via a type 1 link.

In a sixty-third clause, in the wireless communication method in any one of the thirty-fourth clause to the thirty-eighth clause, the TBTT information field for each type 2 AP includes a neighbor AP TBTT offset subfield, a BSSID subfield, a short SSID subfield, a BSS parameters subfield, and an MLD parameters subfield.

In a sixty-fourth clause, in the wireless communication method in the sixty-third clause, the TBTT information field for each type 2 AP includes a 1-octet neighbor AP TBTT offset subfield, a 6-octet BSSID subfield, a 4-octet short SSID subfield, a 1-octet BSS parameters subfield, and a 3-octet MLD parameters subfield.

In a sixty-fifth clause, in the wireless communication method in the forty-first clause, the MLD version subfield of the MLD parameters subfield is set to 0 if the AP MLD with which the reported AP is affiliated is an 11be AP MLD; and/or set to 1 if the AP MLD with which the reported AP is affiliated is a NG AP MLD.

In a sixty-sixth clause, in the wireless communication method in the forty-first clause, the MLD version subfield of the MLD parameters subfield is set to 1 if the AP MLD with which the reported AP is affiliated is an 11be AP MLD; and/or set to 0 if the AP MLD with which the reported AP is affiliated is a NG AP MLD.

In a sixty-seventh clause, in the wireless communication method in the forty-fifth clause or the fifty-third clause, the extended MLD capabilities and operations present subfield is set to 1 if the extended MLD capabilities and operations subfield is present in the common information field; or otherwise, the extended MLD capabilities and operations present subfield is set to 0.

In a sixty-eighth clause, in the wireless communication method in the forty-fifth clause or the fifty-third clause, if the extended MLD capabilities and operations present subfield is set to 1, the MLD capabilities and operations present subfield is set to 1.

In a sixty-ninth clause, in the wireless communication method in the thirty-first clause, the non-AP MLD is a logical entity that has one MAC data service and a single MAC SAP to a logical link control (LLC) sublayer; and the non-AP MLD is capable of supporting more than one affiliated STA, and/or operates using one or more affiliated STAs where each affiliated STA is the type 1 STA or the type 2 STA and at least one affiliated STA is the type 1 STA.

In a sixty-ninth clause, in the wireless communication method in the thirty-second clause, the AP MLD is a logical entity that has one MAC data service and a single MAC SAP to a LLC sublayer; and the AP MLD is capable of supporting more than one affiliated AP, and/or operates using one or more affiliated APs where each affiliated AP is the type 1 AP or the type 2 AP and at least one affiliated AP is the type 1 AP.

In a seventieth clause, in the wireless communication method in the sixty-ninth clause, when the non-AP MLD operates using one or more affiliated STAs, the one or more affiliated STAs includes at least one affiliated type 1 STA.

In a seventy-first clause, in the wireless communication method in the seventieth clause, when the AP MLD operates using one or more affiliated APs, the one or more affiliated APs includes at least one affiliated type 1 AP.

FIG. 10 illustrates a wireless communication method 800 performed by a first AP according to an embodiment of the present disclosure. In some embodiments, the method 800 includes: a block 802, transmitting, by the first AP, a beacon frame or a probe response frame, to a first station (STA), wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

FIG. 11 illustrates a wireless communication method 900 performed by a first STA according to an embodiment of the present disclosure. In some embodiments, the method 900 includes: a block 902, receiving, by the first STA, a beacon frame or a probe response frame, from a first access point (AP), wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

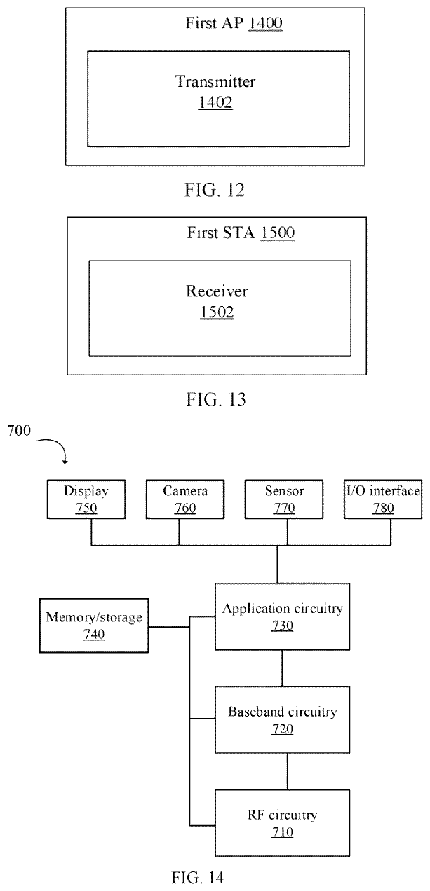

FIG. 12 is a block diagram of a first access point (AP) 1400 according to an embodiment of the present disclosure. The first access point (AP) 1400 includes a transmitter 1402 configured to configured to transmit, to a first station (STA), a beacon frame or a probe response frame, wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

FIG. 13 is a block diagram of a first STA 1500 according to an embodiment of the present disclosure. The first STA 1500 comprises a receiver 1502 configured to receive a beacon frame or a probe response frame from a first access point (AP), wherein the first STA is a type 1 STA affiliated with a non-AP multi-link device (MLD). This can solve issues in the prior art, improve system throughput, improve beam forming training, improve beam tracking, improve frequency diversity gain, reduce power consumption, achieve ultra high throughput, provide good communication performance, and/or provide high reliability.

In some embodiments, the first AP is a type 1 AP affiliated with an AP MLD that has zero or at least one affiliated type 2 AP. In some embodiments, the beacon frame or the probe response frame comprises a target beacon transmission time (TBTT) information field, a multi-link control field, and/or a common information field. In some embodiments, if the first AP corresponds to a transmitted BSSID in a multiple BSSID set or is not in a multiple BSSID set (i.e. if the first AP does not correspond to a non-transmitted basic service set identifier (BSSID)), the beacon frame or the probe response frame comprises the TBTT information field in a reduced neighbor report (RNR) element with a neighbor AP TBTT offset subfield, a BSSID subfield, a short service set identifier (SSID) subfield, a basic service set (BSS) parameters subfield, and/or an MLD parameters subfield, for each of type 2 APs affiliated with the AP MLD or for each of other type 1 APs affiliated with the same AP MLD. In some embodiments, if a second AP affiliated with another AP MLD corresponds to a non-transmitted SSID and the first AP corresponds to a transmitted BSSID in a same multiple BSSID set as the second AP, the beacon frame or the probe response frame comprises the TBTT information field in an RNR element with a neighbor AP TBTT offset subfield, a BSSID subfield, a short SSID subfield, a BSS parameters subfield, and/or an MLD parameters subfield, for each of type 2 APs affiliated with the other AP MLD or for each of other type 1 APs affiliated with the AP MLD.

In some embodiments, if the first AP is in a same co-located AP set as APs affiliated with another AP MLD, the other AP MLD has no affiliated APs operating on a same channel as the first AP, and one AP affiliated with the other AP MLD is in a same multiple BSSID set as an AP affiliated with the AP MLD, the beacon frame or the probe response frame comprises the TBTT information field in an RNR element with a neighbor AP TBTT offset subfield, a BSSID subfield, a short-BSSID subfield, a BSS parameters subfield, a 20 MHz power spectral density (PSD) subfield, and/or an MLD parameters subfield for each type 1 AP of the other AP MLD, and/or the beacon frame or the probe response frame comprises the TBTT Information field in the RNR element with the neighbor AP TBTT offset subfield, the BSSID subfield, the short-BSSID subfield, the BSS parameters subfield, and/or the MLD parameters subfield for each type 2 AP of the other AP MLD. In some embodiments, fields of the BSS parameters subfield are reserved if a reported AP is the type 2 AP. In some embodiments, the fields of the BSS parameters subfield comprise an on-channel tunneling (OCT) recommended field, a member of extended service set (ESS) with 2.4/5 GHz co-located AP field, and an unsolicited probe response active field.

In some embodiments, an MLD version subfield of the MLD parameters subfield indicates a version of the AP MLD with which the reported AP is affiliated. In some embodiments, a BSS parameter change count subfield of the MLD parameters subfield is an unsigned integer and is initialized to 0, that increments when a critical update to a BSS parameter of the reported AP occurs. In some embodiments, if the reported AP is the type 2 AP, the critical update to the BSS parameter of the reported AP comprises a modification of an enhanced distributed channel access (EDCA) parameter set element, a modification of a directional multi-gigabit (DMG) operation element, a modification of an enhanced directional multi-gigabit (EDMG) operation element, an inclusion of a quiet element, an inclusion of a DMG BSS parameter change element, and/or an inclusion of an extended channel switch announcement element.

In some embodiments, if the first AP corresponds to a transmitted BSSID in a multiple BSSID set or is not in a multiple BSSID set (i.e., if the first AP does not correspond to a non-transmitted BSSID), the beacon frame or the probe response frame comprises the multi-link control field and the common information field in a basic multi-link element. In some embodiments, an extended MLD Capabilities And Operations Present subfield of the multi-link control field indicates a presence of an extended MLD capabilities and operations subfield in the common information field. In some embodiments, when an extended MLD capabilities and operations subfield is present in the common information field, an MLD capabilities and operations subfield is also present in the common information field. In some embodiments, a maximum number of simultaneous type 1 link subfield of an MLD capabilities and operations field indicates a maximum number of type 1 STAs affiliated with the MLD that support simultaneous transmission or reception of frames on respective links; and/or is set to a number of affiliated type 1 APs minus 1.

In some embodiments, a maximum number of simultaneous type 2 link subfield of an extended MLD capabilities and operations field indicates a maximum number of type 2 STAs affiliated with the MLD that support simultaneous transmission or reception of frames on respective links; and/or is set to a number of affiliated type 2 APs minus 1. In some embodiments, a link ID subspace boundary subfield of an extended MLD capabilities and operations field indicates a boundary between a type 1 link ID subspace and a type 2 link ID subspace, and/or the link ID subspace boundary subfield is set to a maximum type 1 link ID minus 1.

In some embodiments, the first STA affiliated with the non-AP MLD transmits an association request frame or a reassociation request frame to a third AP. In some embodiments, the third AP is the first AP or a type 1 AP affiliated with another AP MLD and operating at the same link as the first STA. In some embodiments, the association request frame or the reassociation request frame comprises a multi-link control field, a common information field, and a link information field in a basic multi-link element.

In some embodiments, an extended MLD capabilities and operations present subfield of the multi-link control field indicates a presence of an extended MLD capabilities and operations subfield in the common information field. In some embodiments, when an extended MLD capabilities and operations subfield is present in the common information field, an MLD capabilities and operations subfield is also present in the common information field. In some embodiments, a maximum number of simultaneous type 1 link subfield of an MLD capabilities and operations field indicates a maximum number of type 1 STAs affiliated with the MLD that support simultaneous transmission or reception of frames on respective links; and/or is set to the maximum number of type 1 STAs affiliated with the non-AP MLD that support simultaneous transmission or reception of frames minus 1.

In some embodiments, a maximum number of simultaneous type 2 link subfield of an extended MLD capabilities and operations field indicates a maximum number of type 2 STAs affiliated with the MLD that support simultaneous transmission or reception of frames on respective links; and/or is set to the maximum number of type 2 STAs affiliated with the non-AP MLD that support simultaneous transmission or reception of frames minus 1. In some embodiments, a type 1 frequency separation for simultaneous transmit and receive (STR) subfield of an MLD capabilities and operations field indicates a minimum frequency gap between any two type 1 links that is recommended by the non-AP MLD for STR operation; and/or is set to 0 to indicate that no frequency separation information is provided; and/or set to a nonzero value n to indicate that a STR frequency gap is (n−1)×80 MHz. In some embodiments, a type 2 frequency separation for STR subfield of an extended MLD capabilities and operations field indicates a minimum frequency gap between any two type 2 links that is recommended by the non-AP MLD for STR operation; and/or is set to 0 to indicate that no frequency separation information is provided; and/or set to a nonzero value n to indicate that a STR frequency gap is (n−1)×2.16 GHZ.

In some embodiments, a per-STA profile sub-element of the link information field comprises a non-simultaneous transmit and receive (NSTR) indication bitmap subfield in a STA information field. In some embodiments, if the per-STA profile sub-element corresponds to a type 1 link, each bit corresponding to a type 2 link in the NSTR indication bitmap subfield is set to 0. In some embodiments, if the per-STA profile sub-element corresponds to a type 2 link, each bit corresponding to a type 1 link in the NSTR indication bitmap subfield is set to 0. In some embodiments, the AP MLD is a next generation (NG) AP MLD, and a discovery of the NG AP MLD is via a type 1 link. In some embodiments, the TBTT information field for each type 2 AP comprises a neighbor AP TBTT offset subfield, a BSSID subfield, a short SSID subfield, a BSS parameters subfield, and an MLD parameters subfield.

In some embodiments, the TBTT information field for each type 2 AP comprises a 1-octet neighbor AP TBTT offset subfield, a 6-octet BSSID subfield, a 4-octet short SSID subfield, a 1-octet BSS parameters subfield, and a 3-octet MLD parameters subfield. In some embodiments, the MLD version subfield of the MLD parameters subfield is set to 0 if the AP MLD with which the reported AP is affiliated is an 11be AP MLD; and/or set to 1 if the AP MLD with which the reported AP is affiliated is a NG AP MLD. In some embodiments, the MLD version subfield of the MLD parameters subfield is set to 1 if the AP MLD with which the reported AP is affiliated is an 11be AP MLD; and/or set to 0 if the AP MLD with which the reported AP is affiliated is a NG AP MLD. In some embodiments, the extended MLD capabilities and operations present subfield is set to 1 if the extended MLD capabilities and operations subfield is present in the common information field; or otherwise, the extended MLD capabilities and operations present subfield is set to 0. In some embodiments, if the extended MLD capabilities and operations present subfield is set to 1, the MLD capabilities and operations present subfield is set to 1. In some embodiments, the non-AP MLD is a logical entity that has one MAC data service and a single MAC SAP to a logical link control (LLC) sublayer; and the non-AP MLD is capable of supporting more than one affiliated STA, and/or operates using one or more affiliated STAs where each affiliated STA is the type 1 STA or the type 2 STA and at least one affiliated STA is the type 1 STA. In some embodiments, the AP MLD is a logical entity that has one MAC data service and a single MAC SAP to a LLC sublayer; and the AP MLD is capable of supporting more than one affiliated AP, and/or operates using one or more affiliated APs where each affiliated AP is the type 1 AP or the type 2 AP and at least one affiliated AP is the type 1 AP. In some embodiments, when the non-AP MLD operates using one or more affiliated STAs, the one or more affiliated STAs comprises at least one affiliated type 1 STA. In some embodiments, when the AP MLD operates using one or more affiliated APs, the one or more affiliated APs comprises at least one affiliated type 1 AP.

Some embodiments of the present disclosure can be adopted in peer to peer (PTP) communication. The phrase “PTP communication”, as used herein, may relate to device-to-device communication over a wireless link (“peer-to-peer link”) between devices. The PTP communication may include, for example, a Wi-Fi direct (WFD) communication, e.g., a WFD P2P communication, wireless communication over a direct link within a quality of service (QOS) basic service set (BSS), a tunneled direct-link setup (TDLS) link, a STA-to-STA communication in an independent basic service set (IBSS), or the like. Some demonstrative embodiments are described herein with respect to Wi-Fi communication. However, other embodiments may be implemented with respect to any other communication schemes, networks, standards, and/or protocols.

Commercial interests for some embodiments are as follows. 1. Solving issues in the prior art. 2. Improving system throughput. 3. Improving beam forming training. 4. Improving beam tracking. 5. Improving frequency diversity gain. 6. Reducing power consumption. 7. Achieving extremely high throughput. 8. Providing a good communication performance. 9. Providing a high reliability. 10. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or IEEE standards create an end product. Some embodiments of the present disclosure propose technical mechanisms.

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP or STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by a first station (STA), comprising:
receiving, by the first STA, a beacon frame or a probe response frame, from a first access point (AP), wherein the first STA is a type 1 STA affiliated with a non-AP multi-link device (MLD).

2. The wireless communication method of claim 1, wherein the first AP is a type 1 AP affiliated with an AP MLD that has zero or at least one affiliated type 2 AP.

3. The wireless communication method of claim 1, wherein the beacon frame or the probe response frame comprises a target beacon transmission time (TBTT) information field, a multi-link control field, and/or a common information field.

4. The wireless communication method of claim 3, wherein if the first AP corresponds to a transmitted basic service set identifier (BSSID) in a multiple BSSID set or is not in a multiple BSSID set, the beacon frame or the probe response frame comprises the TBTT information field, for each of type 2 APs affiliated with the AP MLD or for each of other type 1 APs affiliated with the same AP MLD.

5. The wireless communication method of claim 4, wherein the TBTT information field is in a reduced neighbor report (RNR) element with a neighbor AP TBTT offset subfield, a BSSID subfield, a short service set identifier (SSID) subfield, a basic service set (BSS) parameters subfield, and/or an MLD parameters subfield.

6. The wireless communication method of claim 3, wherein if a second AP affiliated with another AP MLD corresponds to a non-transmitted SSID and the first AP corresponds to a transmitted BSSID in a same multiple BSSID set as the second AP, the beacon frame or the probe response frame comprises the TBTT information field, for each of type 2 APs affiliated with the other AP MLD or for each of other type 1 APs affiliated with the AP MLD.

7. The wireless communication method of claim 6, wherein the TBTT information field is in an RNR element with a neighbor AP TBTT offset subfield, a BSSID subfield, a short SSID subfield, a BSS parameters subfield, and/or an MLD parameters subfield.

8. The wireless communication method of claim 3, wherein if the first AP is in a same co-located AP set as APs affiliated with another AP MLD, the other AP MLD has no affiliated APs operating on a same channel as the first AP, and one AP affiliated with the other AP MLD is in a same multiple BSSID set as an AP affiliated with the AP MLD, the beacon frame or the probe response frame comprises the TBTT information field in an RNR element with a neighbor AP TBTT offset subfield, a BSSID subfield, a short SSID subfield, a BSS parameters subfield, a 20 MHz power spectral density (PSD) subfield, and/or an MLD parameters subfield for each type 1 AP of the other AP MLD, and/or the beacon frame or the probe response frame comprises the TBTT Information field in the RNR element with the neighbor AP TBTT offset subfield, the BSSID subfield, the short SSID subfield, the BSS parameters subfield, and/or the MLD parameters subfield for each type 2 AP of the other AP MLD.

9. The wireless communication method of claim 4, wherein fields of the BSS parameters subfield are reserved if a reported AP is the type 2 AP.

10. The wireless communication method of claim 9, wherein the fields of the BSS parameters subfield comprise an on-channel tunneling (OCT) recommended field, a member of extended service set (ESS) with 2.4/5 GHz co-located AP field, and an unsolicited probe response active field.

11. The wireless communication method of claim 4, wherein an MLD version subfield of the MLD parameters subfield indicates a version of the AP MLD with which the reported AP is affiliated.

12. The wireless communication method of claim 4, wherein a BSS parameter change count subfield of the MLD parameters subfield is an unsigned integer and is initialized to 0, that increments when a critical update to a BSS parameter of the reported AP occurs.

13. The wireless communication method of claim 12, wherein if the reported AP is the type 2 AP, the critical update to the BSS parameter of the reported AP comprises a modification of an enhanced distributed channel access (EDCA) parameter set element, a modification of a directional multi-gigabit (DMG) operation element, a modification of an enhanced directional multi-gigabit (EDMG) operation element, an inclusion of a quiet element, an inclusion of a DMG BSS parameter change element, and/or an inclusion of an extended channel switch announcement element.

14. The wireless communication method of claim 3, wherein if the first AP corresponds to a transmitted BSSID in a multiple BSSID set or is not in a multiple BSSID set, the beacon frame or the probe response frame comprises the multi-link control field and the common information field in a basic multi-link element.

15. The wireless communication method of claim 14, wherein an extended MLD capabilities and operations present subfield of the multi-link control field indicates a presence of an extended MLD capabilities and operations subfield in the common information field.

16. The wireless communication method of claim 14, wherein when an extended MLD capabilities and operations subfield is present in the common information field, an MLD capabilities and operations subfield is also present in the common information field.

17. The wireless communication method of claim 14, wherein a maximum number of simultaneous type 1 link subfield of an MLD capabilities and operations field indicates a maximum number of type 1 STAs affiliated with the MLD that support simultaneous transmission or reception of frames on respective links; and/or is set to a number of affiliated type 1 APs minus 1.

18. The wireless communication method of claim 14, wherein a maximum number of simultaneous type 2 link subfield of an extended MLD capabilities and operations field indicates a maximum number of type 2 STAs affiliated with the MLD that support simultaneous transmission or reception of frames on respective links; and/or is set to a number of affiliated type 2 APs minus 1.

19. A first station (STA), comprising:
a memory;
a transceiver; and
a processor coupled to the memory and the transceiver;
wherein the first STA is configured to perform:
receiving a beacon frame or a probe response frame, from a first access point (AP), wherein the first STA is a type 1 STA affiliated with a non-AP multi-link device (MLD).

20. A first access point (AP), comprising:
a memory;
a transceiver; and
a processor coupled to the memory and the transceiver;
wherein the AP is configured to perform:
transmitting a beacon frame or a probe response frame, to a first station (STA), wherein the first STA is a type 1 STA affiliated with a non-AP multi-link device (MLD).
